(19) United States
(12) Patent Application Publication
(10) Pub. No.: US 2012/0233115 A1
(43) Pub. Date: Sep. 13, 2012

(54) REAL-TIME DOCUMENT MANAGEMENT SYSTEM AND METHOD

(75) Inventors: Michael Dalewitz, New York, NY (US); Richard Eichenberg, New York, NY (US)

(73) Assignee: PEAK DISCOVERY, INC., New York, NY (US)

(21) Appl. No.: 13/042,631

(22) Filed: Mar. 8, 2011

(51) Int. Cl. G06F 17/30

(52) U.S. Cl. 707/608; 707/E17.005

(57) ABSTRACT

A computer system for document includes a SQL database for storing information related to the document review and a time-tracker portal for tracking time worked on the documents to be reviewed. A separate Document Management Application is provided for entering information into the database and a further User Interface is provided for managing the document review project. These combined applications are system agnostic and can be run on any operating system and on separate computers communicating over a network, e.g. the WWW. A key aspect of the system is the ability to track the time worked by document reviewers in near real-time, in contrast to previous hourly or quarter-hourly levels. The method of the present invention provides customized reporting and forecasting based upon numerous provided metrics or user-customizable metrics.

### BACKGROUND OF THE INVENTION

I. Field of Invention.

The present invention relates generally to litigation support and document review, and more particularly, to a system and method for quality control of this process.

II. Description of the Related Art.

Business disputes, legal disputes and regulatory investigation involve a common theme, the discovery process. Responding to a discovery request is a complex process involving data collection, processing, review and production. Many, corporations and law firms turn to outside consultants to perform this service.

An important part of this process is “Document review”. Document review is a task usually performed by attorneys. Document review requires the attorneys to assess the relevance and/or responsiveness of documents, using knowledge about the facts of the case and the issues of law. Later stages of document review (sometimes called privilege review or second level review) consider whether a document is privileged (on the basis of attorney-client communication, work product and/or other reason) and may be either withheld from production or redacted for content.

Much of the document review process has been streamlined and sped up with the use of various software products that allow the document review attorneys to “tag” the documents in a database according to that documents' status and to track the time worked on the document. This allows for greater quality control of the document review process.

One crucial aspect of quality control is the tracking of time spent working on documents. Traditional methods of tracking time included manually entering 14-hour increments on time sheets, or manually entering ¼ hour increments into a tracking program on a computer. In addition, these time sheets would usually not be available for review until the next day at the earliest.

This illustrates a need in the current systems to be able to update the time worked on a project in smaller increments and to be able to update the time sheet on a more frequent basis in a way that can be tracked in almost real-time by the person in charge of tracking and controlling the time spent on these projects.

Another problem with most current litigation support software is that it is proprietary and tied to a fixed system. This creates problems with interoperability when, for example, the attorneys responsible for the document review and the clients providing the documents and project requirements are in different locations and working on different systems.

This illustrates a need in the current document review software that allows users to access the database from a computer system, preferably using a network, such as the Internet and the world wide web (WWW).

Accordingly, for the reasons above, there is a current need for a web-based portal to a document review database that tracks document reviewers' time in near ‘real-time’ and is platform neutral.

### SUMMARY OF INVENTION

The present invention addresses the above problems by establishing a web-based portal for document review projects, A SQL database is created for storing and tagging documents undergoing document review. An instance of the database is securely created that is accessible via the Internet.

A Time Tracker portal in the system is a web-based portal hosted on a document reviewer's computer. This software can track the reviewer's work and time and update this information in real-time in the SQL database.

A User Portal in the system is a web-based portal hosted in the user's computer. This application allows the user to establish different projects, specific tasks to be performed within those projects and specific reviewers to perform those tasks. The user can also generate various reports, for example a Project Cost report.

A key aspect of the present invention are that the invention is ‘platform-neutral’, with separate features of the program able to be hosted on different computers all accessing each other through network, e.g. WWW, portals. Another key feature is that the information in the database used to provide user information is updated in near real-time.

### BRIEF DESCRIPTION OF THE DRAWINGS

The invention may best be understood by referring to the following detailed description and accompanying drawings that are used to illustrate embodiments of the present invention. In the drawings:

FIG. 1 is a schematic diagram of the system in accordance with the invention.

FIG. 2 is a flowchart illustrating the steps for tracking document reviewer's time in accordance with the invention.

FIG. 3 is a flowchart illustrating the steps for entering documents into the database of the present invention.

FIG. 4 is a flowchart illustrating the steps taken in the User Portal to create new tasks and assign new reviewers to projects.

### DETAILED DESCRIPTION OF THE INVENTION

in describing a preferred embodiment of the invention illustrated in the drawings specific terminology will be used for the sake of clarity. However, the invention is not intended to be restricted to the specific terms selected, and it is to be understood that each specific term includes all the technical equivalents that operate in a similar manner to achieve a similar purpose.

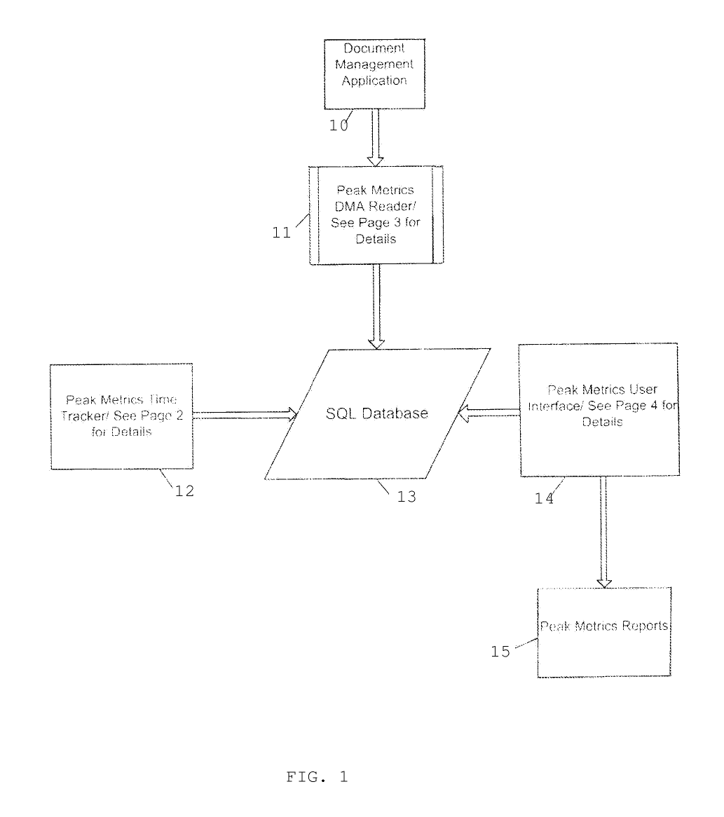

FIG. 1 is an overview of the Document Management Application 10 (“DMA”) according to the present invention. In the middle of the figure is a SQL (“Structured Query Language”) database 13. A SQL database is a database designed for working with “relational” data. It is especially useful for providing user queries which allow users of the database to query the database and produce reports from the queries. The preferred embodiment of the present invention uses a SQL database 13; however other types of databases are not excluded.

The SQL database 18 can contain numerous “tags” in the database for each document entered into the database table. These can include document name, file size, start date and time, total time worked, cost, reviewer name, privileged vs. non-privileged, relevant vs. non-relevant, etc. Many tags can be standard for all documents, such as time worked on a document and the document reviewer's name, but new customized fags can be created for each individual database.

The SQL database 13 is designed to be accessed from 3 different software programs, all accessing each other via a network. This may be any form of network but in the preferred embodiment can be web-based (accessible over the WWW). These 3 programs can be hosted in different computers and at different locations, but all accessing the SQL database 13 via preferably the internet.

The preferred means for entering information into the SQL Database 13 will be the DMA Reader 11. The DMA Reader will be established using the User Interface 14, as detailed below. Detailed tracking of the time will be done on each reviewer's computer using the Time Tracker 12 and that time information will be updated in almost real-time in the Database 13.

In summary, the primary means for entering information related to Documents in the Database 13 will be the DMA Reader 11. Information related to time worked on these Documents will be updated in the Database 13 using the Time Tracker portal 12. The primary means for retrieving information from the Database 13 will be the User Interface 14. This information can then be used by the User Interface to generate reports using various metrics and graphing functions.

A document review project can typically involve a corporation which has to provide the documents, a law firm that will manage the project, and a document review firm with contract attorneys that will review the documents. Each of these firms has different tasks related to the project and needs to be able to access the SQL database 13 through different portals.

At the top is the DMA Reader 11. This is the portal through which data regarding the documents under review is entered into the SQL 13. This software can be hosted in different locations, but can preferably be located on the computers used by users responsible for entering the documents into the database 13, either the firm performing discovery or the document review firm. Because different users need to access this database 13 from different locations, a separate ‘instance’ of the database 13 will be created in a location that is securely accessible over the internet by the users and contract attorneys.

At the left is the Time Tracker portal 12 through which data regarding the time taken on the project is entered. This portal can be hosted preferably on the document reviewers' computers.

On the right is the User Interface 14. This is the interface where users of the present, invention query the database 13 and generate reports using the Report function 15. It is also where users can establish different projects and decide which attorneys will review the documents in the projects based upon various metrics generated by the database reports.

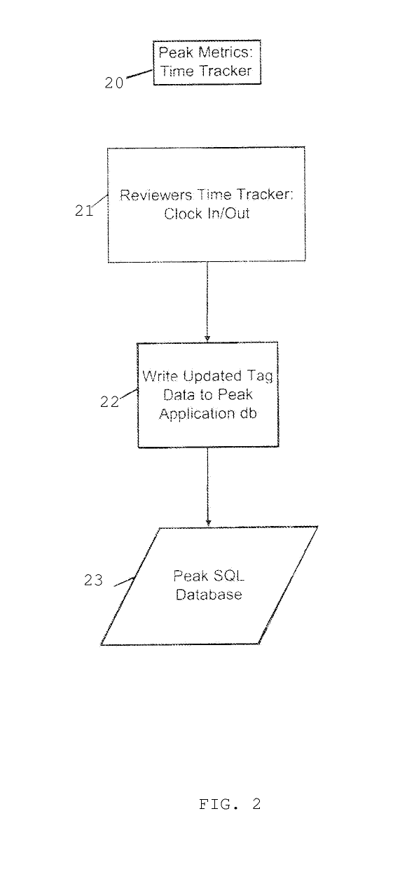

FIG. 2 is a flowchart illustrating the Time Tracker portal 20. In the preferred embodiment, when a document reviewer clocks in or out 21 the reviewer indicates which document or project he his working on. The ‘tag’ in the database indicating the time worked on a given document is then updated 22 when this information is transferred to the SQL database 23 via the Time Tracker portal 20. The database will be updated 23, indicating the start and finish times for work done with that document.

The updated tag data will be sent frequently, almost real-time. The time information in the database can track the time worked down to the resolution on the document reviewers' computer, e.g. down to the second. This is in stark contrast to traditional worksheets which tracked the attorney's time down to the ¼ hour.

This information can then be used to calculate the time taken for work on this document and can be used to calculate various time-based metrics to measure the work and quality of work done by various reviewers, it takes some time for the computer hosting the database to rebuild an instance of the database. So while the time can be tracked on a second-by-second basis, the database cannot be updated so quickly. It currently takes in the region of 30 minutes to rebuild the database. This means that a user who is tracking the time on a given project can track the time to a very detailed degree, but only up to the time of the last creation of the hosted ‘instance’ of the database.

In the preferred embodiment the user of the Timer Tracker portal 20 can access the portal using a web-based interface. An additional element of the Time Tracker portal 20 can be the use of a message on the reviewer's computer screen that requires the user to perform some work at his computer within some fixed time interval, set by the client, if the reviewer does not work at his computer within that time interval then the Time Tracker portal 20 will log the reviewer out from the system so that the SQL database 23 will no longer be updated. In this way the reviewer must be working at his computer in order for the portal and SQL database 23 to be updated with the time worked. This prevents document reviewers from leaving their computers for extended periods of time and make it appear as if they are actually working on a given project.

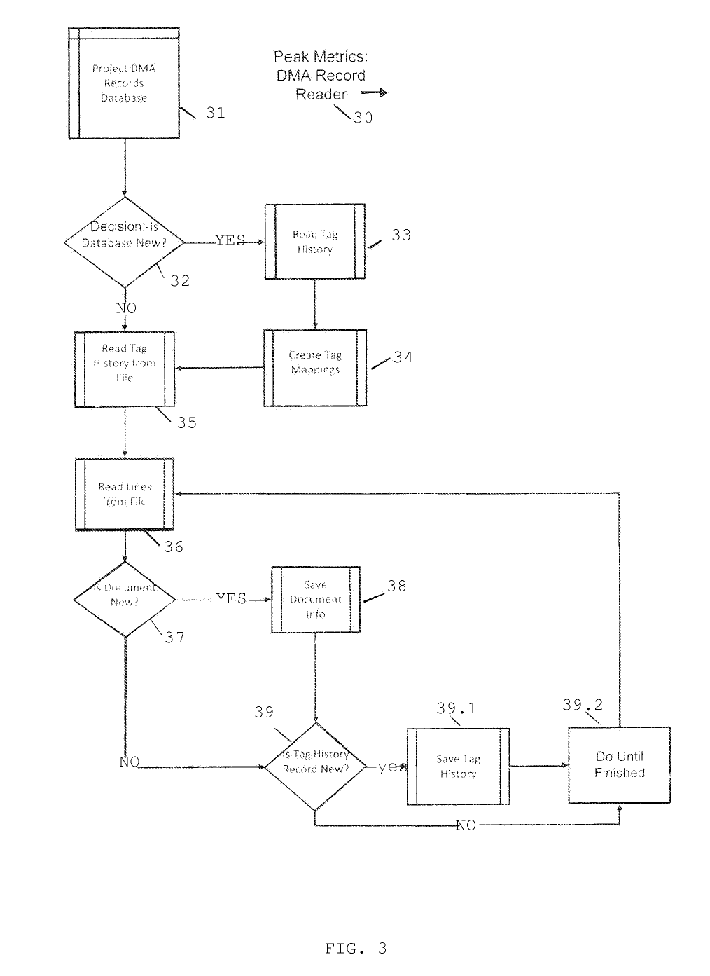

FIG. 3 is a flowchart illustrating the workings of the Document Management Application (“DMA”) Record Reader 30. In the preferred embodiment of the present invention a SQL database 31 with project and document information can be hosted on a separate computer from the computers hosting the various portals in the present invention. An instance of this database will be created by reading in the information as in FIG. 3.

In the first step the system will control for whether the database is “new” 32, i.e. whether an existing instance of that database has been created within the system, if the database is new then the system will read the tag mappings 33 in the database, create new tag mappings 34, and then read those tag mappings into the system SQL 35.

The SQL can comprise many documents, each with their own tags and tag histories. The system will read through the file 38 and check each document to control for whether the document is new 37. In this way new documents can be entered into an existing database.

If the document is new then that information is saved into the system 38. In either case, the tag history for that particular document is then read into the SQL. If the tag history is new 39 then the tag history is read into the file 391. If the tag history is not new then the process continues by moving on to the next document in the SQL 38.

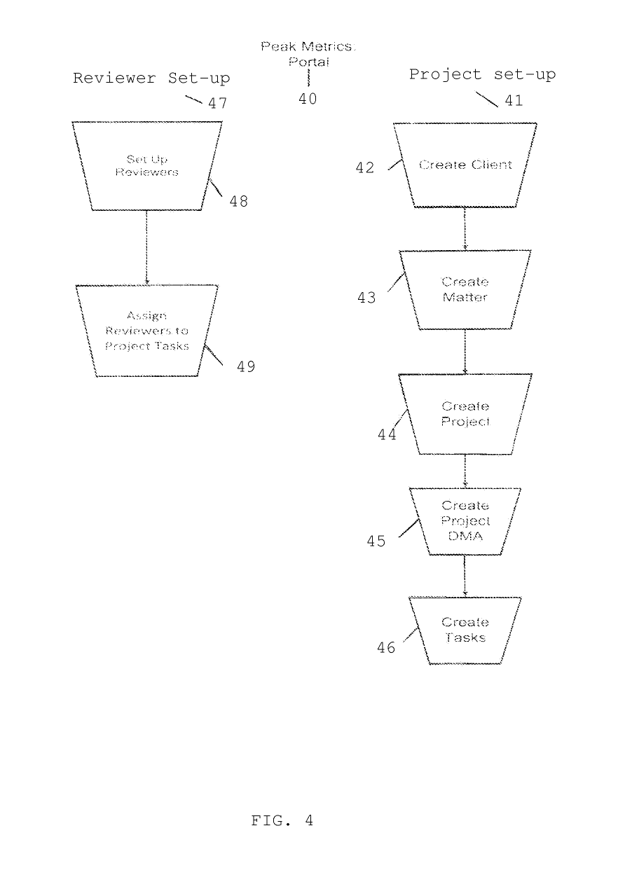

In FIG. 4 is a flowchart for three methods used in the user portal 40, a preferably web-based interface to the SQL database. This is the primary user interface into the system according to the present invention. The user portal 40, i.e. the client screen, will have screen elements for the user to perform Administrative tasks (not shown), create Clients 42, create Matters 43 related to the clients, set up Projects 44 for the clients, set up Project DMAs 45 for the clients and set up Tasks 48 for the clients. The method illustrated is the Project Setup 41. In sequence the user will create a Client 42, a Matter 43, a Project 44, a Project DMA 45 and Tasks 48.

Typically the user will be an attorney representing the Client undergoing discovery in a legal or regulatory process. The attorney will need to create a new Client 42 if the client doesn't already exist in the database. A given client might have multiple “matters” (cases) which require document reviews. The attorney can create a new “matter” 43 where required. A given matter might have multiple projects. For example, the client might have documents coming from multiple locations: separate projects could be established 44 for each of these.

Project creation 44 is a key element of the present invention. Creating a project 44 includes choosing the documents to be reviewed as part of that project. A ‘Project Forecaster’ (not shown) is included as part of the software in the present invention. The user will be able to forecast costs and time to completion for the documents in the project. The costs will be based upon the rates for the individual reviewers chosen for the project. The rates can be calculated on a per document or per hour basis. Completion dates can also be calculated using the documents/hour of individual reviewers.

Using this Project Forecaster the user can optimize the costs and time for individual clients, if cost is more important then the user can, for example. Choose less expensive reviewers. If time is more important then the user can select reviewers who have a higher documents/hour rate.

Then the project DMA (“Document Management Application”) is created 45. This is a key step in the process and ties back into the flowchart illustrated in FIG. 3. The attorney representing the Client will typically be acting as the project manager, managing the discovery process. By creating the DMA project 45 he will be establishing the means for entering all the documents and associated fags into the SQL database.

The attorney can then create tasks 48 that need to be performed on these documents e.g. which documents to review. The user will then set up document reviewers 48 and assign reviewers 49 to the tasks he has created. These reviewers will typically be assigned on the basis of their cost and efficiency. These costs and efficiency can be calculated using various reports that the user generates.

Creation of a Task 46 is primarily to set up the type of review. While there might be more types of review, the 3 main types of review are 1^{st}-level Review, a 2^{nd}-level or Detail level review and finally a QC Review. When the user is on the Create Task 48 screen he may view the Status of the task, the dates, the rate charged, the reviewer(s) and the Priority Level.

While these are shown in sequence, each element may, in fact be performed separately and in different orders. When a user is logged in to the system the user may switch from one element of the flowchart to another at any time. For example, the user may Create Tasks 46 for a given Project and then switch to Creating a new Client 42 if the user is performing an Administrative Task (not shown), the user may then switch to Creating a new Matter 43 for an existing Client.

The elements of the flowchart are dependent in respect to Tasks being dependent upon a Project DMA. A Project DMA must first be Created 45 before Tasks can be Created 46. A Project, must first be Created 44 before a Project DMA is created 45 for that Project. A Matter must first be created 43 before a Project related to that Matter is created 44. Finally, a Client must first be Created 42 before a Matter is Created 43 for that Client.

For example, a user may log in to the system and Create several Clients 42. Once these have been, created then the user may go about peforming other administrative duties, for example. The user may return to the system at any time to Create Matters 43 for any or all existing Clients. Once these Matters have been created 43 the use may create Projects 44 for these and other Matters or move back up the flowchart 41 to Create other Matters 43 or Clients 42. It can be seen that each element in the flowchart is dependent upon the previous step in the flowchart. But once and existing element in the flowchart has been created the user may return to any previous step in order to move down a separate branch of a flowchart for a different client.

Report generation is a key aspect of the present invention. The SQL database is filled with information and tags that allow a user to calculate various ‘metrics’ that can be used to estimate e.g. costs and efficiency.

An example report could be Reviewer Metrics. This would measure a reviewer's cost and efficiency. Tags exist in the database for each Reviewer, the Documents that reviewer has reviewed, the number of Pages reviewed, Hours worked, etc. In addition, most document reviews have a quality control review whereby reviewer's work spot-checked for accuracy. The quality control reviewer will add tags for Accuracy (e.g. 90%) to the database.

Accuracy is calculated based upon the number of changes that need to be made by the quality control reviewer. For a more relevant statistic the quality control is done on batches of documents rather than on individual reviewers. Different reviewers may review different types of documents of differing difficulty and it's difficult to compare the quality of a reviewer reviewing different types of documents, if a random sample batch is taken then the level of difficulty within that batch should be similar. A given batch is taken and a QC review is performed. Within this batch, individual reviewers can then be compared.

Using this information the portal can generate a report which will calculate e.g. the documents/hour reviewed, the pages/hour, the costs etc.

By generating a report showing which document reviewers review documents more quickly a user can calculate which reviewers to use on a project that needs to have documents reviewed more quickly in order to meet a particular deadline. By generating a report showing the cost of each reviewer (e.g. on a per document or per hour basis) a user can assign lower cost reviewers in order to meet cost containment goals.

Because the database contains detailed information on each reviewer, their time worked (at an almost real-time level of detail), the documents worked on etc., many ‘statistics’ can be maintained on each reviewer. By using just the information regarding time, accuracy and documents reviewed, a quick picture can be generated that will provide the user with information that can be used to assign the ideal reviewers to a particular assignment in order to meet cost goals, time deadlines or other project goals.

Since the present invention is preferably accessed via the Internet, the information presenting in the Reviewer Metrics report can be in the form of a ‘dashboard’ which presents the information visually in forms that make the information quickly understandable to the user. This can include various graphing functions.

Other reports that are possible include Quality Control (“QC”) Change Details. These show where QC changes were made. Activity Metrics can be reported, showing speed, performance and accuracy data, further subdivided by specific activities. Tag Metrics and Tag Metrics Details can be reported, showing which tags are added and subtracted to the SQL, filterable by the task, and further identifying the tags by the reviewer, time and dates.

Other reports can include a Source Metric which can report information about the chain of custody of the documents being reviewed. A Work History report can summarize historical time and task data on an hourly, daily or weekly basis.

While many detailed report functions will be provided with the software according to the present invention, the invention and database has a wealth of information that can be used to generate customized reports using the metrics of the user's choice. Metrics currently included in the present invention include the percent work completed and the estimated completion date. In addition, metrics are available for the total number of documents, total pages, and total file size reviewed or to be reviewed, and total number of documents and total pages that are tagged/reviewed. Further document metrics include the number of sources and the unique tags in a document.

Cost metrics include the cost so far, cost per document, estimated completion cost, and forecasted cost per document. These costs can be calculated to the minute. Metrics for time include the start and end time on all tasks and the total time taken. Just as the costs can be calculated to the minute, so can the time taken for tasks be calculated to the minute. Because hourly rates are typical, metrics are included for individual documents/pages per hour. Typically reviewers work in groups and group metrics are included such as group documents/pages per hour.

Forecast metrics are included such as the forecasted completion date and the forecasted number of reviewers needed for the project. Quality control (‘QC’) metrics are included such as % accuracy, the number of QC changes, the number of documents of QC'd, critical changes from 1^{st} level to QC, and Changes (QC changing 1st level reviewer) at Reviewer and Batch Level.

It will be seen from the above description that the present invention differs from current document review software in several ways. First, the software is ‘platform agnostic’, being accessible by any computer over a network e.g. the WWW. Second, the reviewers are tracked in near real-time as contrasted with the current ¼-hour levels.

Third, the QC accuracy is tracked by taking random batches of documents, allowing for a more accurate comparison of different reviewers. Fourth, the current invention allows for the creation, in near real-time, of customized reports as discussed above. Fifth, the invention provides a ‘dashboard’ overview of projects and tasks assigned to those projects.

The above description of the invention and its preferred embodiments has been presented for purposes of illustration only. It is not meant to be exhaustive or to limit the invention to the precise embodiments disclosed. It will be obvious to a practitioner skilled in the art that many alternative embodiments are possible without departing from the spirit and scope of the present invention. Accordingly, the invention should only be limited by the claims included below.

What is claimed is:

1. Method for managing a document review in a computer network comprising a plurality of computers, means for communication between said computers and a database for storing for information, said method for managing document review comprising the steps of:
creating a client;
creating a matter for said client;
creating a project for said matter;
creating a Document Management Application for said project;
creating a task for said Document Management Application.

2. The method of claim 1 further comprising the steps of:
assigning at least one document reviewer to said task.

3. The method of claim 1 wherein said Document Management Application further comprises the steps of:
entering documents into said database by first checking if an instance of said database exists;
if an instance exists then read tag mappings in said database, create new tag mappings for said documents and enter said tag mappings into said database;
if no instance exists then read the tag history from said document;
check if each document is new;
if said document is new then reading the lines from said document into said database;
if said document is new or not new then checking is said tag history is new;
if said tag history is new then reading said tag history into said database;
if said tag history is not new then continue the process with the next document.

4. The database of claim 1 wherein said database is a SQL database.

5. The database of claim 1 wherein said database further comprises tags for storing information related to document names, file size, reviewer name, total time worked, costs related to said document, starting date and time, relevance, and privilege.

6. The method of claim 1 further comprising the steps of:
reviewer clocking in;
reviewer indicating which document is worked on;
tagging time and document information in said database;
if no work is performed in a preset fixed time period then logging out of said database.

7. The method of claim 6 wherein said time is updated in said database to a resolution not more than the minimum time measurable on said computer network.

8. The method of claim 1 further comprising the steps of:
calculating costs for completion of said project;
calculating dates for completion of said project;

9. The method of claim 8, further comprising the steps of:
optimizing said project to minimize said costs.

10. The method of claim 8, further comprising the steps of:
optimizing said project to minimize said completion date.

11. The method of claim 1, said step of creating a task further comprising the steps of:
tagging said task as a 1^{st}-level, 2^{nd}-level or Quality Control level review.

12. The method of claim 1 further comprising the steps of:
generating a report based upon metrics calculated using tags in said database.

13. The method of claim 12 wherein said metrics comprise at least one of activity metrics, tag metrics, source metrics, quality control metrics, and reviewer metrics.

14. The method of claim 13 wherein said reviewer metrics further comprised cost metrics, efficiency metrics and accuracy metrics.

15. The method of claim 12 wherein said report is visually generated as a dashboard using graphing functions.

16. A computer system for managing document review comprising:
a database for storing information related to said document review;
a time-tracker portal for tracking time worked on said document review;
a Document Management Application for entering information regarding said documents into said database;
a User Interface for managing said document review, retrieving information from said database and generating reports using information from said database.
